(19) United States
(12) Patent Application Publication
(10) Pub. No.: US 2008/0088399 A1
(43) Pub. Date: Apr. 17, 2008

(54) SERIES IMPEDANCE MATCHED INDUCTIVE POWER PICK UP

(76) Inventor: Michael John Mayo, Palo Alto, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/862,169

(22) Filed: Sep. 26, 2007

Related U.S. Application Data
(60) Provisional application No. 60/847,630, filed on Sep. 27, 2006.

(51) Int. Cl. H01F 21/06

(52) U.S. Cl. 336/118; 336/119

(57) ABSTRACT

A non-contact power distribution system is provided. The system includes a pair of primary conductors defining a pathway and a moving assembly having a pick up coil coupled to the pair of primary conductors through an air gap. The pick up coil has a capacitor in series with the pick up coil, wherein the pick up coil provides power from the pair of primary conductors to the moving assembly to power the moving assembly along the pathway. A transport assembly and a method for obtaining power in a non-contact power transfer system are provided.

### CLAIM OF PRIORITY

The present application claims priority under 35 U.S.C. § 119(e) from U.S. Provisional Patent Application No. 60/847,630, filed Sep. 27, 2006, which is incorporated by reference in its entirety for all purposes.

### BACKGROUND

Semiconductor fabrication facilities utilize automated moving vehicles for the transportation of semiconductor substrates within the facility. In some systems, the moving vehicles are powered through inductively coupled electric power provided across a gap. In order to operate in the most efficient manner, the resonant frequencies between primary and secondary circuits are matched. Because the system, i.e., the coupling between the primary and the secondary circuits, is not a tightly coupled system, the effect of inductance must be accounted for. The system and method described herein enable a simple technique for accounting for the effect of the inductance so that the power can be transferred as efficiently as possible.

### SUMMARY

This invention provides a non-contact power pick up system and moving assembly that incorporates a power pick up core with series capacitive impedance. It should be appreciated that the present invention can be implemented in numerous ways, including as a method, a system, or an apparatus. Several inventive embodiments of the present invention are described below.

In one embodiment of the invention, a non-contact power distribution system is provided. The system includes a pair of primary conductors defining a pathway and a moving assembly having a pick up coil coupled to the pair of primary conductors through an air gap. The pick up coil has a capacitor in series with the pick up coil, wherein the pick up coil provides power from the pair of primary conductors to the moving assembly to power the moving assembly along the pathway.

In another embodiment, a transport assembly configured to capture power from a non-contact power distribution system is provided. The transport assembly includes a power pick up assembly having a secondary coil configured to obtain power from a primary source. The secondary coil has a capacitor in series with a leakage inductance of the secondary coil. In one embodiment, the transport assembly is a ceiling mounted vehicle.

In yet another embodiment, a method for obtaining power in a non-contact power transfer system is provided. The method initiates with obtaining power from a primary coil through a secondary coil, wherein the primary coil and the secondary coil are separated by an air gap. The method includes transferring the power through the secondary coil efficiently, wherein the transferring includes, matching a magnitude of the impedance due to the leakage inductance with a capacitor placed in series with the secondary coil. The method also includes powering or driving a moving assembly with the transferred power.

Other aspects and advantages of the invention will become apparent from the following detailed description, taken in conjunction with the accompanying drawings, illustrating by way of example the principles of the invention.

### BRIEF DESCRIPTION OF THE DRAWINGS

Aspects of the present invention will become apparent from the following detailed description, taken in conjunction with the accompanying drawings, illustrating by way of example the principles of the invention.

FIG. 1 is a parametric equivalent circuit of a pickup coil.

FIG. 2 is a simplified schematic diagram illustrating one embodiment of a circuit whereby the leakage inductance is matched by a capacitor in parallel with the pickup and load resistance.

FIG. 3 is a simplified schematic diagram illustrating an embodiment where series impedance matching is utilized in the circuit in accordance with one embodiment of the invention.

FIG. 4 is a simplified schematic diagram illustrating a series impedance matching circuit in accordance with one embodiment of the invention.

FIG. 5 is a simplified schematic diagram illustrating a non-contact power pickup in accordance with one embodiment of the invention.

FIG. 6 is a simplified schematic diagram illustrating one exemplary embodiment as an architecture for a non-contact power distribution in accordance with one embodiment of the invention.

FIG. 7 is a simplified schematic diagram illustrating the signals generated in order to trigger the short circuit switches of FIG. 6 in accordance with one embodiment of the invention.

### DETAILED DESCRIPTION

An invention is described for a system and method for considering the effect of inductance in order to provide a match that will enable the efficient transfer of power. It will be obvious, however, to one skilled in the art, that the present invention may be practiced without some or all of these specific details. In other instances, well known process operations have not been described in detail in order not to unnecessarily obscure the present invention.

The embodiments described herein relate to the provision of inductively coupled electric power across a gap to a mobile or portable power-consuming vessel or assembly, such as moving vehicles, typically employed within semiconductor fabrication facilities. With regard to modern semiconductor fabrication facilities, the use of non-contact power distribution systems is prevalent to provide power for the movement of vehicles or some other movable assembly. The use of inductively coupled power to move vehicles is enabled through the use of effective power coupling circuits in either or both the primary and secondary circuits. In the embodiments described below, within the pickup circuitry for the specified moving assembly, the effects of inductance are matched through capacitors in order to enable the system to operate efficiently. In the embodiment's described below different architectures are discussed so that the effect of the equivalent leakage inductance is considered and matched. In one embodiment, the placement of a capacitive element in series with the inductance provides a simplified design to cancel the effects of the inductance in order to provide the most efficient transfer of power.

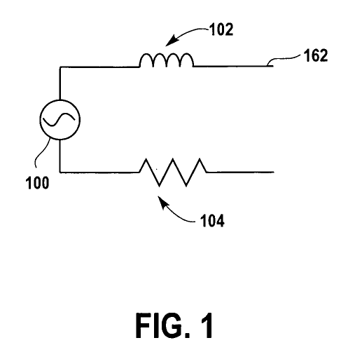

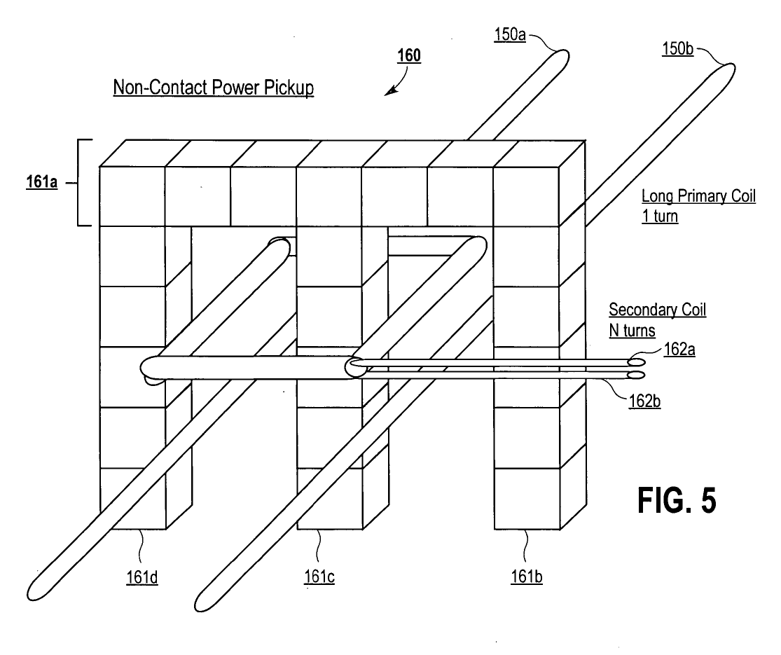

FIG. 1 illustrates a power collection system that utilizes a parallel connected capacitor to couple power out of a pickup coil and is the equivalent circuit for the pick up. It should be appreciated that FIG. 1 is the electrical representation of FIG. 5. Within FIG. 1, the leakage inductance is representative of the poor coupling between the vehicle and the primary coils. The leakage inductance drops 102 the output voltage as current is drawn into a load. Because of the large air gap in the non-contact power systems described herein, the coupling between the primary and the secondary circuits is not optimal as represented by a relatively large leakage inductance. On its own, because of the leakage inductance, the pickup coil can deliver only a small amount of power. It should be appreciated that the power requirements would be dependent on the system design. Thus, the power supplies described herein are exemplary and not meant to be limiting. Wire 162 represents the wires coming from a pickup unit as described in more detail below. In one embodiment, a single ferrite core supplies approximately 150 watts of power, limited by the magnetic saturation of the ferrite. Voltage from ideal voltage source 100 is determined by the number of turns or windings, and in one embodiment, approximately one volt is generated per turn. Within FIG. 1, the impedance matching is required in order to operate at the optimum efficiency to compensate for leakage inductance 102 of the pickup winding. Because of the poorly coupled transformer between the primary and secondary coils, the leakage inductance cannot be ignored and must be addressed. Resistance 104 represents the equivalent loss resistance due to the nature of the coupling. The embodiments described below provide a capacitor to cancel the effect of the leakage inductance to allow more current to flow, thereby allowing more power to be drawn by the load. The capacitance is selected to cancel the effect the leakage inductance at the operating frequency. The embodiments below discuss the placement of the capacitor relative to the inductance and the consequences of that placement.

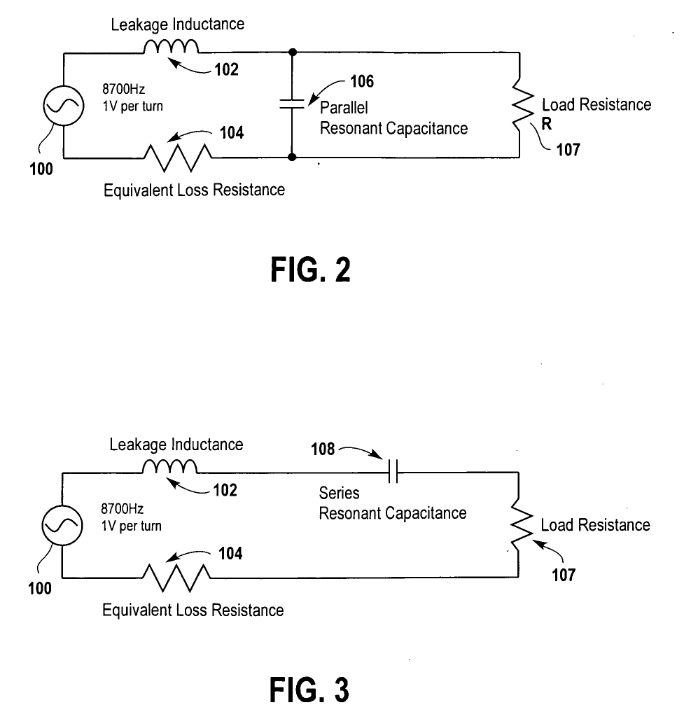

FIG. 2 is a simplified schematic diagram illustrating one embodiment of a circuit whereby the leakage inductance is matched by a capacitor in parallel with the pickup and load resistance. One skilled in the art will appreciate that for the maximum power transfer:
r−jwL=(R*I/jwC)/(R+I/jwC),
where R represents the load resistance 107, C represents the capacitance 106, L represents the inductance, j represents the square root of minus one, w (omega) represents the angular frequency, which is 2πf, and r represents the equivalent loss resistance in the pickup coil. This relationship corresponds to that which makes inductance L resonate with capacitance C at angular frequency w. Zero resistance R results in zero power output and voltage accompanied by a small power dissipation in the pickup coil. Increasing the load resistance R increases the Output power and voltage. Thus, the power output of the system is controlled by reducing the value of load resistance R as less power is needed. With a large value of load resistance R the voltage may rise high enough to destroy components. It should be appreciated that because of this potential, it is necessary to use capacitors of higher voltage ratings than the normal operating voltage, in case the load is disconnected. One feature of the regulation used for this embodiment is that when the system is idle, the system is configured to short the input. In addition, the calculation necessary to size the capacitor is complex as it involves the inverse of complex conjugates.

FIG. 3 is a simplified schematic diagram illustrating an embodiment where series impedance matching is utilized in the circuit in accordance with one embodiment of the invention. It should be noted that FIG. 3 represents the pickup coil, in the same way as FIG. 2, with an AC voltage source 100 an equivalent leakage inductance 102 and equivalent loss resistance 104. FIG. 3 illustrates a series matching capacitance 108 and load resistance 107 as used in one embodiment of the invention. The embodiment represented through FIG. 3 illustrates a circuit where the leakage inductance 102 is matched by a capacitor 108 in series with a pickup and the load resistance. This is in contrast to the circuit of FIG. 2 where the capacitor 106 is in parallel with the the load resistance 107. In contrast to the parallel match scheme represented in FIG. 2, increasing the value of resistance R in the embodiment of FIG. 3 reduces the power output and increases the output voltage of the pick up. Thus, if the load is disconnected in the embodiment of FIG. 3, no current flows and the output voltage equals that of the AC source 100. If, however, the output is shorted, then the current can become relatively large and place a large voltage on both the coil and the capacitor. In one embodiment, the power controller design incorporates circuitry that in the case of an output short, modifies the impedance matching so as to limit the current. One skilled in the art will appreciate that in both FIGS. 2 and 3, the resonant capacitance is used to cancel most of the effects of the leakage inductance caused by the imperfect coupling of the primary and secondary coils of the power coupling transformer, thereby allowing optimal extraction of power from in the primary coil. With regard to FIGS. 2 and 3, it should be noted that the parallel resonant circuit of FIG. 2 has the highest current at no load, while the series impedance matching represented in FIG. 3 has the lowest current at no load. In addition, in the parallel resonant circuit of FIG. 2, when there is no current in the load, the highest voltage is present on the pickup windings since the pickup windings include the leakage inductance. In contrast, the series impedance matching circuit of FIG. 3 has no high voltage problem, i.e., there is no voltage drop across the leakage inductance with no load current. Thus, for the parallel impedance matching circuit of FIG. 2, the coil needs to be shorted when the voltage is too high. That is, at no load the coil needs to be shorted and therefore a unique regulating scheme must be adopted. However, the series impedance matching circuit of FIG. 3 is configured such that there is no current when there is no load. In short, the parallel resonant capacitor cancels the effect of the leakage inductance but generates a very high voltage across the capacitor's terminals, and the pickup coil, when there is no load. The series resonant capacitor produces essentially the same voltage as an ideal transformer with no load since no current flows through the leakage inductance or the series resonant capacitor. Therefore, no voltage develops across the circuit elements in this embodiment in the no load condition.

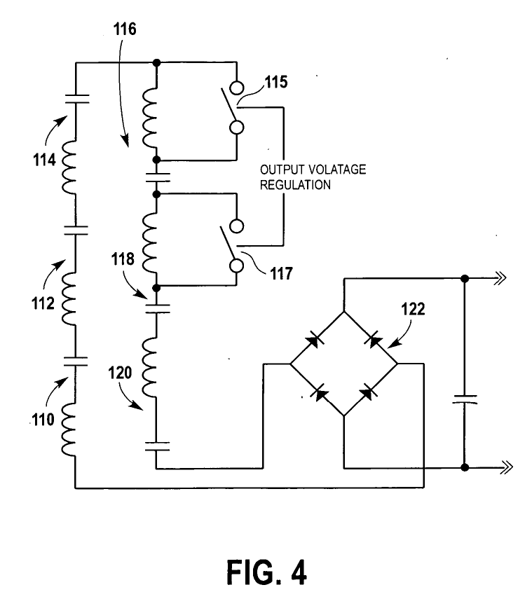

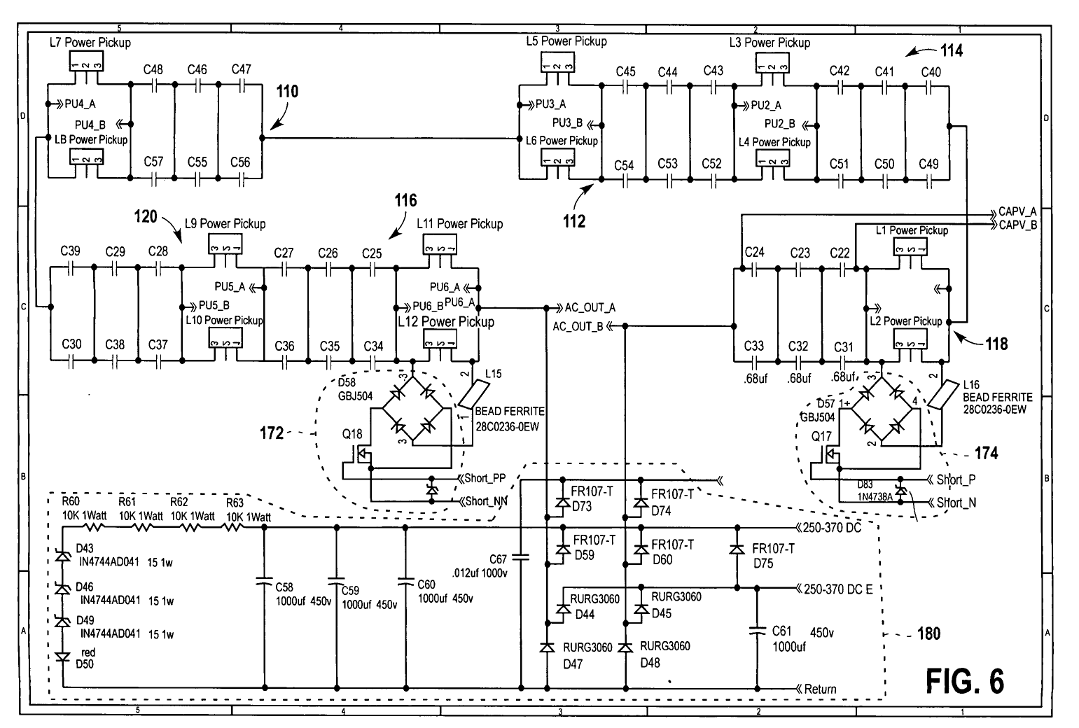

FIG. 4 is a simplified schematic diagram illustrating a series impedance matching circuit in accordance with one embodiment of the invention. The circuit of FIG. 4 includes 12 cores in one embodiment. It should be appreciated that the cores are arranged in pairs 110, 112, 114, 116, 118 and 120 as further specified with reference to FIG. 6. When the cores are arranged in pairs, the cores are in effect six sources of alternating current which may be later rectified to direct current. In this embodiment, at low load, two coil pairs may be shorted and the other four coil pairs are producing the later rectified direct current. The two coils that are shorted are illustrated within regions 116 and 118, through corresponding switches 172 and 174. It should be appreciated that many different configurations of series coils and capacitors are possible. The cores do not have to be configured in parallel pairs in series in one embodiment. That is, the system may include single cores in series or some mixture thereof. It should be noted that configuring the parallel pairs in series provides additional power, i.e., higher voltage. In one embodiment, the cores may be arranged for different output voltage and power requirements. In addition, there are multiple ways of implementing shorting switches 172 and 174. For example, relays or a semiconductor device, such as a pair of back-to-back metal oxide semiconductor field effect transistors (MOSFETs), or a single MOSFET with bridge rectifier 122 as illustrated in FIGS. 4 and 6. In one embodiment, bridge rectifier 122, also referred to as a diode bridge, maintains polarity with a single field effect transistor and a single switch. The exemplary circuit of FIG. 4 is further described in more detail with reference to FIG. 6.

FIG. 5 is a simplified schematic diagram illustrating a non-contact power pickup in accordance with one embodiment of the invention. In FIG. 5, primary coil 150a and 150b eventually loop on one end and are connected to a power supply on the other end. It should be noted that primary coil 150a and 150b have the same current traveling therethrough but the current is traveling in opposite directions. Ferrite E-coil 160 is movably coupled to primary coil 150a and 150b. It should be appreciated that primary coil 150a and 150b may also be referred to as primary conductors. E-coil 160, which may be referred to as an E core includes top structure 161a with three extensions 161b-d extending therefrom, It should be appreciated that E-coil 160 does not have to be composed of ferrite, as laminated steel alloys or powdered iron may also be utilized. As illustrated, E-coil 160 partially envelopes each primary conductor between the vertical portions of the E-coil. Because of the non-contact nature and the air gap between the secondary coil, i.e., E-coil 160, and the primary coils, there is some loss of coupling between the primary coils 150a and 150b and secondary coils 162a and 162b. E-coil 160 of FIG. 6 may be located in a moving assembly, such as a vehicle or other transporter utilized to move substrates including flat panel displays, as well as solar panels, within a semiconductor fabrication facility. The moving assembly may also be referred to as a transport assembly and may be configured to transport front open unified pods (FOUPs) in one embodiment. In another embodiment, the moving assembly may be a ceiling guided vehicle used for the transport of semiconductor substrates either within a container or without a container holding the semiconductor substrates. In another embodiment, the transport assembly or moving assembly may be used to transport flat panel displays or other large substrates and the power captured through the pick up may be used to power a blower of the transport assembly rather than power the movement or driving of the assembly. One skilled in the art will appreciate that the embodiments described herein may be extended to any moving assembly and is not meant to be limited to a moving assembly for semiconductor fabrication facilities.

As illustrated in FIG. 5, the coupling of the E-coil 160 in the moving vehicle with the primary conductors forms an air gap transformer. E-coil 160 functions as the pickup coil side of the air gap transformer. The primary conductors function as the primary coil side of the air gap transformer. As discussed above, the E-coils partially envelope the primary conductors. That is, top structure 161a is disposed above one surface of the primary coil, extensions 161b and 161 d extend along the outer edges of the primary coil, and extension 161c extends between the conductors of the primary coil. A vehicle with an E-core can be removed from the primary coil by lifting the vehicle upward, and in one embodiment, the E-core may slide along the primary conductors. Other coils could be used such as, but not limited to, a pair of C-cores. In one embodiment, the primary conductors are supported (e.g., from the ceiling). In essence, a magnetic coupling is formed between the primary conductors and the secondary coils. This magnetic coupling allows power to be transferred between the primary conductors and the secondary coil. Accordingly, the embodiments are not limited to an E-coil, as other shapes are possible. A magnetic coupling is formed between primary coil 150a and 150b and secondary coils 162a and 162b. In the preferred embodiments described herein, leads 162a and 162b of the pick up will have a capacitor in series with one of the leads, rather than across the leads. That is the capacitors are in series with the leakage inductance as illustrated in FIGS. 3, 4, and 6, rather than in parallel as illustrated in FIG. 2. When placed in series, a magnitude of the capacitive impedance is substantially equal to a magnitude of the impedance of the leakage inductance at a given operating frequency.

FIG. 6 is a simplified schematic diagram illustrating one exemplary embodiment as an architecture for a non-contact power distribution in accordance with one embodiment of the invention. FIG. 6 is configured to further illustrate the embodiment discussed with reference to FIG. 4. That is, regions 110, 112, 114, 116, 118 and 120 relate to the regions of FIG. 4 numbered similarly. As can be seen, each power pickup in regions 110, 112, 114, 116, 118 and 120 includes a coil in series with a plurality of capacitors. Any number of capacitors may be used instead of three pairs of capacitors to achieve a desired capacitance based on the design needs of the specific system. Within regions 172 and 174 a field effect transistor and diode bridge will short out the corresponding coils in order to protect limit voltage at low load. Region 180 is configured to perform bulk filtering of alternating current off of the pickup. It should be noted that while three different output current paths are illustrated through the bulk filtering scheme, a single output or any other number of suitable outputs may be accommodated through a specific architecture dependent on the design of the system and motors being powered through these embodiments as one skilled in the art will appreciate. In one exemplary embodiment, six core pairs are used, each pair wound to produce 80 volt (V) direct current (DC) peak when full-wave rectified. The cores are arranged in pairs so that they are, in effect, six sources of 80 V DC (open circuit) and 300 watts (W) maximum power per pair at 40 V. Thus, at no load, two coil pairs are shorted and the other four coil pairs are producing 320 V DC rectified and filtered at the output. At maximum power output, none of the coil pairs are shorted and the six coil pairs together produce 240 V rectified and filtered at the output. In this embodiment, the twelve individually wound ferrite cores each comprise 6 turns and an open circuit output of 80V root mean square (rms), and short circuit current of 0.6 A rms. The coils are connected in parallel pairs and the pairs connected in series with impedance matching capacitors interposed. A circuit shorts up to two winding pairs under low load conditions in order to keep the rectified output voltage below 360 V DC. Another circuit may short two winding pairs when there is a load fault short circuit in one embodiment.

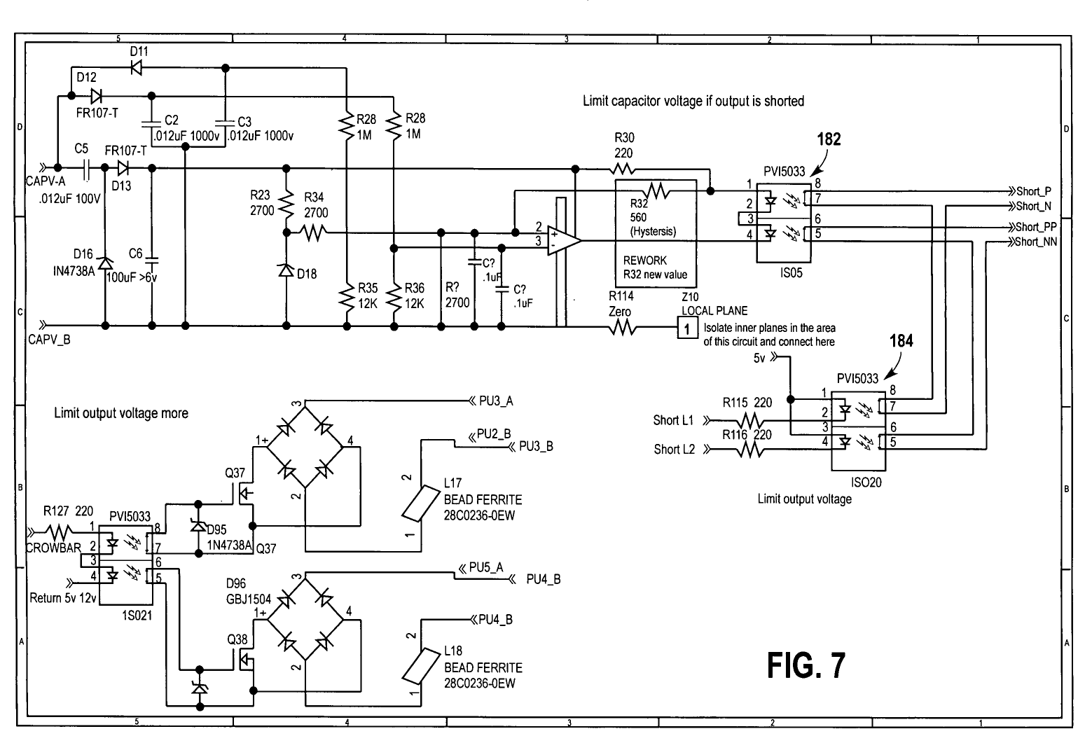

FIG. 7 is a simplified schematic diagram illustrating the signals generated in order to trigger the switches 172 and 174 of FIG. 6 in accordance with one embodiment of the invention. In one embodiment, two opto-isolator 182 and 184 in series are controlled by voltage monitoring circuits in order to short out one or two of the coils 172 or 174 of FIG. 6.

In summary, the embodiments described herein provide for a non-contact power distribution system in which the pickup for a moving assembly traversing a path along a conveying system has series capacitance as described above. The conveying system may be a system owned by the assignee. The transport or moving assembly which conveys the substrates includes a capacitive element in series with a coil and the leakage inductance, such as described in U.S. Pat. No. 6,095,054, which is owned by the assignee and incorporated herein by reference for all purposes. The capacitive element cancels an effect of the stray inductance of the pick up coil due to poor coupling. In the system, a power supply provides AC current to a wire that loops back to the power supply in one embodiment. A pick up coil coupled to a pair of primary conductors includes capacitors in series with the pick up coil and the leakage inductance. Thus, when is series, the magnitude of the capacitive impedance at the operating frequency substantially equals the magnitude of the impedance of the leakage inductance of the pick up coil.

By now, those of skill in the art will appreciate that many modifications, substitutions, and variations can be made in and to the materials, apparatus, configurations, and methods of the substrate transferring system of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalence.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims. It should be appreciated that exemplary claims are provided below and these claims are not meant to be limiting for future applications claiming priority from this application. The exemplary claims are meant to be illustrative and not restrictive.

What is claimed is:

1. A non-contact power distribution system, comprising:
a pair of primary conductors defining a pathway;
a moving assembly having a pick up coil coupled to the pair of primary conductors through an air gap, the pick up coil having a capacitor in series with the pick up coil, wherein the pick up coil provides power from the pair of primary conductors to the moving assembly to power the moving assembly along the pathway.

2. The system of claim 1, wherein the pick up coil includes multiple coils, each of the multiple coils having at least one capacitor in series with corresponding coil.

3. The system of claim 1, further comprising:
a power supply propagating a current through the pair of primary conductors.

4. The system of claim 1, wherein the pair of primary conductors are configured as a loop emanating from a power supply.

5. The system of claim 1, wherein the pick up coil includes an E-core, the E-core having an arm with multiple extensions extending therefrom, wherein one of the multiple extensions extends between the pair of primary conductors.

6. The system of claim 5, wherein the pick Up coil includes a secondary coil winding around the one of the multiple extensions.

7. The system of claim 2, wherein the moving assembly includes a switch configured to short one of the multiple coils.

8. The system of claim 2, wherein the multiple coils are configured as parallel pairs in series.

9. The system of claim 1, wherein a magnitude of capacitive impedance is substantially equivalent to a magnitude of impedance due to leakage inductance.

10. A transport assembly configured to capture power from a non-contact power distribution system, comprising:
a power pick up assembly having a secondary coil configured to obtain power from a primary source, the secondary coil having a capacitor in series with a leakage inductance of the secondary coil.

11. The transport assembly of claim 10, wherein the power pick up assembly includes a ferrite core having an extension disposed between conductive lines of the primary source.

12. The transport assembly of claim 11, wherein the secondary coil winds around the extension.

13. The transport assembly of claim 10, wherein the transport assembly is configured to transport semiconductor substrates.

14. The transport assembly of claim 10, wherein an air gap exists between the secondary coil and conductive lines of the primary source.

15. The transport assembly of claim 9, wherein the power from the primary source is used to propel the transport assembly along a track suspended from a ceiling.

16. A method for obtaining power in a non-contact power transfer system, comprising:
obtaining power from a primary coil through a secondary coil, wherein the primary coil and the secondary coil are separated by an air gap;
transferring the power through the secondary coil efficiently, the transferring including,
matching a magnitude of the impedance due to the leakage inductance with a capacitor placed in series with the secondary coil; and
powering a moving assembly with the transferred power.

17. The method of claim 16, further comprising:
shorting windings of the secondary coil when there is no load on the moving assembly.

18. The method of claim 16, further comprising:
detecting a no load condition; and
shorting the secondary coil in response to the detecting.
